(19) United States
(12) Patent Application Publication
(10) Pub. No.: US 2017/0258564 A1
(43) Pub. Date: Sep. 14, 2017

(54) ONE VISIT DENTURE

(71) Applicant: Larell Surgical Consultants, Inc., Carmel Valley, CA (US)

(72) Inventor: Lawrence Norman Wallace, Carmel Valley, CA (US)

(21) Appl. No.: 15/605,636

(22) Filed: May 25, 2017

Related U.S. Application Data
(63) Continuation of application No. 14/555,391, filed on Nov. 26, 2014, now abandoned.
Application No. 14/555,391 is a continuation-in-part of application No. 12/743,780, filed on Aug. 3, 2010.
(60) Provisional application No. 61/910,005, filed on Nov. 27, 2013.
(60) Provisional application No. 61/003,816, filed on Nov. 20, 2007.

(51) Int. Cl. A61C 13/07; A61C 13/00; A61C 13/271

(52) U.S. Cl. CPC A61C 13/0025; A61C 13/26; A61C 13/0024

(57) ABSTRACT

A denture is manufactured in a single visit using a pre-formed thermoplastic acrylic dental template chosen from a plurality of different sized dental templates, based on the size of a patient's alveolar edentulous ridge. The dental template includes a base thermoplastic acrylic with prosthetic teeth attached thereto. A viscous material such as an acrylic is added to the selected dental template and the dental template with the added viscous material is placed on the patient's alveolar edentulous ridge. The viscous material is then allowed to solidify to form a rigid or semi-rigid material with the template in proper position in three planes and properly border molded. After solidification a denture is formed that consists of a first base thermoplastic acrylic portion in conterminous relation with a second portion formed of the solidified material that had been added as a viscous material, and with teeth joined to the base thermoplastic acrylic portion.

### RELATED APPLICATION

This application claims priority under 35 USC 119 from U.S. Provisional Application Ser. No. 61/910,005 filed on Nov. 27, 2013, titled ONE VISIT DENTURE by Lawrence Norman WALLACE, the entire disclosure of which is incorporated herein by reference

### BACKGROUND

The present invention relates to medical devices and, more specifically to dentures and a method for fabricating a denture in one visit.

Many patients require dentures but do not have easy access to dental care, either because of monetary limitations or geographical limitations. Many patients are older and live in nursing homes or assisted living facilities, making it difficult for those patients to go to the dentist's office once, let alone visit the office four to five times as required for conventional dentures. Additionally, conventional dentures are expensive and not fully covered by insurance and not covered at all by Medicare. Nonetheless, functional dentures are important in maintaining general health, decreasing the incidence of chronic disease, lowering overall medical costs while offering a higher quality of life and sense of self-esteem.

Missing teeth have a variety of implications, including impairment of mastication, speech defects, swallowing disorders, nutrition intake, distorted facial contour, and overall physical and emotional discomfort. Headaches and other illnesses are often related to missing teeth. Replacement of missing teeth is therefore a necessity that is significant to emotional and physical health and well-being.

Conventional dentures are fabricated in dental offices and typically require four to five visits by the patient. During the first visit at the dentist's office, a preliminary impression is taken to make a custom mold of the mouth. That mold may be sent to the laboratory to make custom impression trays. During the second visit to the dentist, the custom impression trays are checked and adjusted and the dentist also takes final impressions. The corresponding laboratory procedures involve creating a cast master mold, a stabilized based plate, and a wax occlusal rim. During the third visit to the dentist, the dentist determines the maxillo-mandibular relation, selects the teeth for the denture, and takes a bite registration. The corresponding laboratory work involves setting the anterior and posterior teeth, thus completing a wax denture for the patient to try. During the fourth visit to the dentist, the dentist checks the aesthetics and functionality of the wax up dentures, checks the occlusal and vertical dimension, and makes any required corrections. The dentures are sent to the lab to be processed and finished. The fifth visit to the dentist involves the delivery of the dentures, a final check for fit and then, finally, the dentures are given to the patient for home use.

One article suggests that the process of fabricating a denture can be accomplished in three appointments. This procedure is described in the article entitled The Three Appointment Denture Technique as Presented by Robert H. Griffiths, D.D.S. and Don Kaylor, C.D.T., printed by the Council on Prosthetic Services and Dental Laboratory Relations in May 1979, in a pamphlet entitled Compilation of Reduced Fee Denture Techniques. In the first, 45 minute appointment, the dentist conducts an examination of the patient which involves examining the tissue and structures, taking a panoramic radiograph, discussing patient history, selecting impression trays, taking facial measurements, determining the tentative vertical and centric relationship, and selecting the teeth and teeth shades. Stabilized base plates should then be received from the lab so that a wax-up can occur. During the second, 20 minute appointment, a preliminary fit analysis of the wax setup occurs and necessary adjustments are made. Between the second and third appointments, the lab must complete the final set of dentures. The third, 20 minute appointment, involves checking the final set of dentures and instructing the patient on how to use the dentures.

Most notably, the proposed three visit procedure only results in a cost saving when the dentist office is able to work closely with the dental laboratory. Additionally, the procedure still requires making a wax model for the first try-in. Making a wax setup requires a significant amount of time and expense.

Sekendur, U.S. Pat. No. 6,079,981, discloses a method for making a customized denture from standard sized segments of prefabricated prosthetic teeth which may be joined and adjusted to fit an individual's mouth. Each prosthetic tooth is bonded to a prosthetic gum segment. The gum segments of each prosthetic tooth are joined to form the gum line. The prosthetic teeth are first selected and then evaluated in the patient's mouth by the dentist, conformed in the mouth or on a model of the mouth to form the denture, and finally cured to form the finished denture.

Saitoh, et. al., U.S. Pat. No. 5,304,062, discloses a prosthetic denture precursor and a method for making the same. The prosthetic denture precursor comprises at least one artificial tooth and a photopolymerizable denture base material which holds the root portion of the artificial tooth. The method of making the prosthetic denture precursor does not require making a wax denture, as the photopolymerizable denture base can be deformed prior to exposure to light. After the tooth is adjusted to a dentally operative position, the base is irreversibly hardened by exposure to light.

Hazer, et al., U.S. Pat. No. 4,583,947, discloses a custom denture and method for making the same. A standard-sized base is selected and fitted with artificial teeth. The teeth are fit into the base and secured by a U-shaped appliance which stabilizes the teeth in their relative positions in the sockets. To determine the appropriate standard base size to select, the dentist takes an impression of the patient's oral cavity. From the impression, upper and lower models are cast, allowing the dentist to select the most appropriate standard-sized base. The bases are then conformed to the surface contours using the casted models and finally, the artificial teeth are secured.

Other methods of making custom dentures have failed to fully address the issue of being able to produce the dental device in a single visit and doing so at a reduced cost, such as may be at the level of Medicaid reimbursement. Thus, patients who do not have easy access to a dental office and those who cannot afford the procedure are precluded from dental treatment which is necessary for physical and emotional health. Furthermore, many dentists choose not to make dentures because the process requiring multiple visits is not profitable. Other methods also require the use of an off-site dental laboratory, adding to time and cost.

It would therefore be desirable to provide a custom denture that overcomes the shortcomings and limitations of conventional dentures and the conventional methods for making dentures

### SUMMARY

To address these and other needs, and in view of its purposes, one aspect of the present invention provides a pre-formed denture template with teeth in place, and which requires only one step and only one sitting, to be made into a finalized, customized denture. The sitting may be a visit to a dental office according to one exemplary embodiment.

According to one aspect, the invention provides a method for forming a denture for a patient in a single dental office visit. The method comprises providing a plurality of denture templates having different sizes, each having been pre-formed to a pre-formed shape and comprising a base acrylic portion with prosthetic teeth adjoined thereto, selecting a first dental template of the plurality of dental templates that has a size generally corresponding to a size of the patient's edentulous alveolar ridge but does not fit conformably, i.e., exactly thereto. The method further comprises adding an impression material which may be a reline or other viscous material, to the first dental template and positioning the first dental template on the patient's edentulous alveolar ridge to mold the impression material to conform to the contours of the patient's edentulous alveolar ridge and vestibule. The method further comprises allowing the impression material to solidify to produce a customized, rigid or semi-rigid molded portion thereby forming a denture comprised of the prosthetic teeth, the base acrylic portion and the solidified molded portion which includes a custom lining. The steps of selecting, adding, positioning and allowing may advantageously take place in one visit.

According to another aspect, the present invention provides a denture formed according to such method and including two acrylic sections. A template is formed of a first acrylic portion and includes teeth coupled directly to the first acrylic portion. A second acrylic portion is conterminous with the first acrylic portion and conforms to a patient's edentulous alveolar ridge and may be rigid or semi-rigid.

According to another aspect, the invention provides a denture comprising teeth and a denture base consisting of two acrylic portions including a template formed of a first acrylic portion and coupled directly to the teeth and a second acrylic portion adjacent and conterminous with the first acrylic portion and being conformed to a patient's edentulous alveolar ridge.

### BRIEF DESCRIPTION OF THE DRAWINGS

The present invention is best understood from the following detailed description when read in conjunction with the accompanying drawings. It is emphasized that, according to common practice, the various features of the drawings are not necessarily to scale. On the contrary, the dimensions of the various features may be arbitrarily expanded or reduced for clarity. Like numerals denote like features throughout the specification and drawings.

FIG. 1 is a flowchart illustrating the process for producing a denture in one office visit in accordance with the invention.

FIGS. 2A-2D illustrate an exemplary maxillary denture template in accordance with the present invention. FIG. 2A is a perspective view of the exemplary maxillary denture template. FIG. 2B is a side view of the exemplary maxillary denture template. FIG. 2C is a front view of the exemplary maxillary denture template. FIG. 2D is a cross-sectional view of the exemplary maxillary denture template.

FIG. 3 is a perspective view of an exemplary mandibular denture template in accordance with the present invention.

FIG. 4 is a perspective view illustrating a viscous material added to the mandibular denture template shown in FIG. 3.

FIGS. 5A to 5D correspond to FIGS. 2A-2D and illustrate an exemplary maxillary denture formed from the exemplary maxillary denture template of FIGS. 2A-2D in accordance with the present invention. FIG. 5A is a perspective view of the exemplary maxillary denture formed in accordance with the present invention. FIG. 5B is a side view of the exemplary maxillary denture formed in accordance with the present invention. FIG. 5C is a front view of the exemplary maxillary denture and FIG. 5D is a cross-sectional view of the exemplary maxillary denture formed in accordance with the present invention.

FIG. 6 illustrates a set of exemplary maxillary-mandibular dentures being worn by a patient.

### DETAILED DESCRIPTION

The present invention provides for making a denture for a patient from a pre-formed denture template device, in one sitting such as a visit to a dental office or another location.

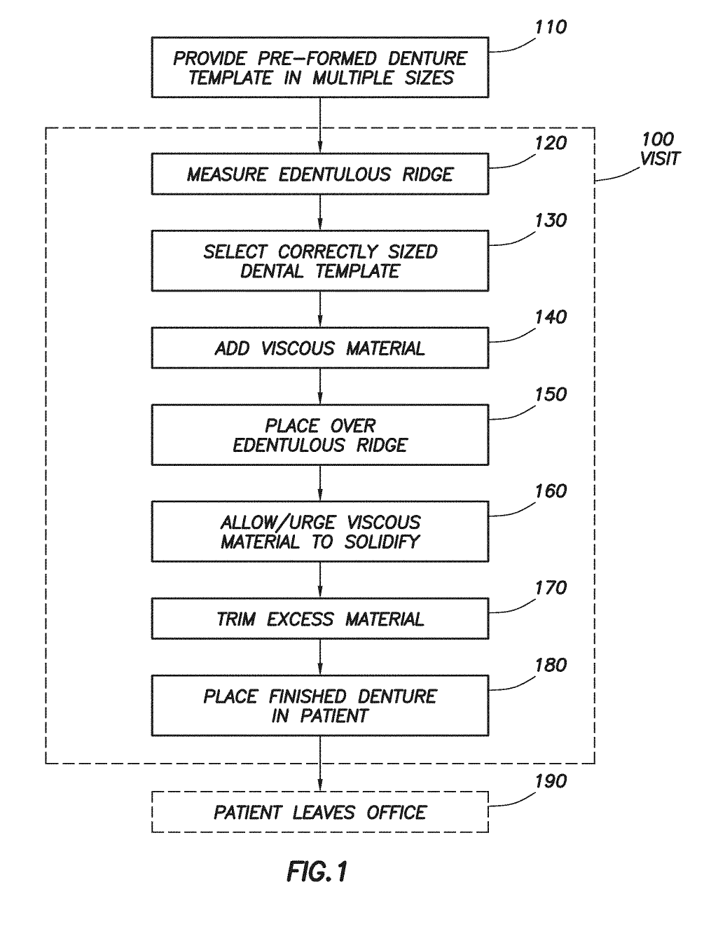

Referring to FIG. 1, prior to the patient's office visit 100, pre-formed dental templates are provided in multiple standard sizes at step 110. At step 120, the patient's edentulous alveolar ridge is measured and at step 130, the appropriately sized dental template is selected. Viscous material such as an acrylic is added at step 140 and the denture template with the viscous material is placed over the edentulous alveolar ridge of the patient at step 150 and serves as an impression material. At step 160, the viscous material is allowed to solidify to form the denture. At step 170, the excess solidified material is trimmed and at step 180, the finished denture is worn by the patient. The manufacture of the denture is complete in one office visit. At step 190, the patient leaves the dental office with the customized, finished denture as formed in one office visit. Note that the above flowchart illustrates one exemplary method for forming the completed denture but various variations and further details of the process are also within the purview of the invention and are disclosed herein, in conjunction with the following figures.

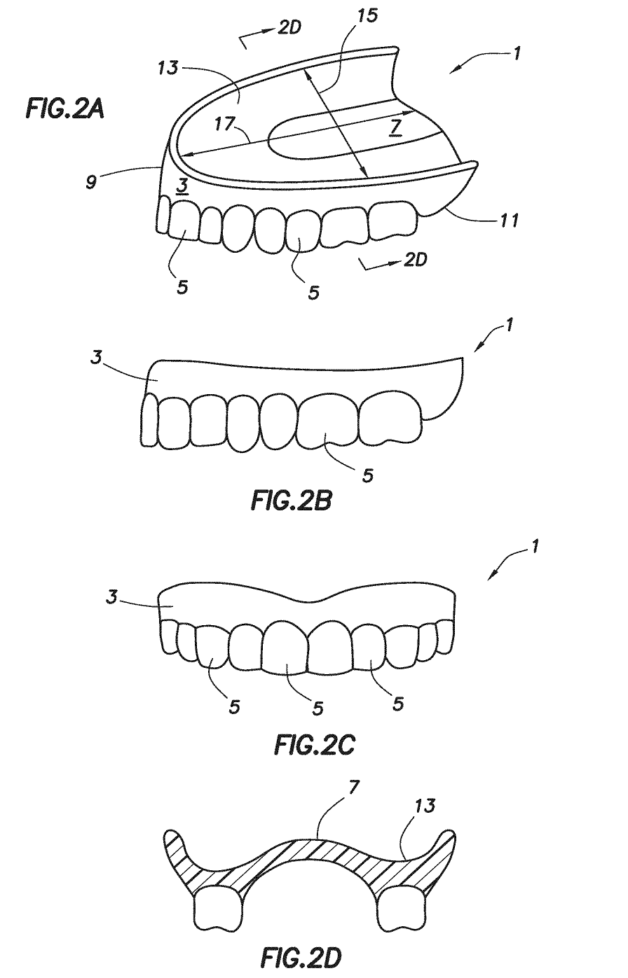

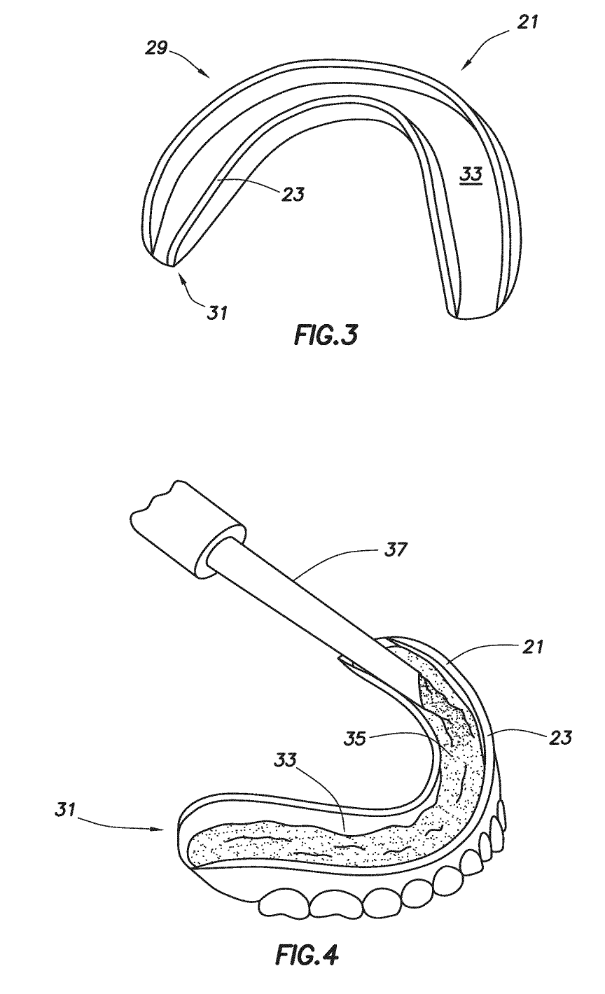

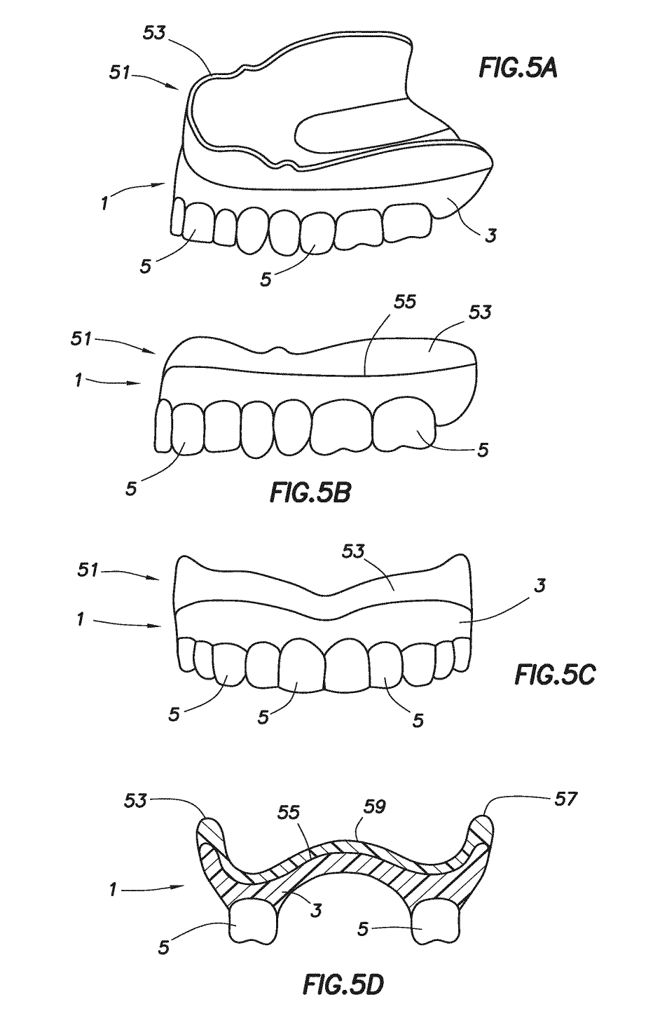

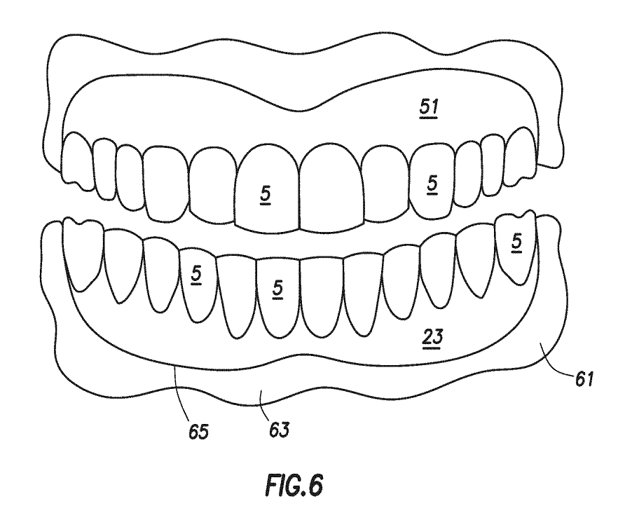

FIGS. 2A-2D illustrate an exemplary pre-formed dental template in accordance with the invention. FIGS. 2A-2D illustrate a maxillary denture template used to produce the maxillary denture shown in FIGS. 5A-5D but it should be understood that the method of the invention can be can be practiced upon a mandibular denture template such as shown in FIGS. 3 and 4, to produce a final customized mandibular denture. The inventive method of manufacturing a denture from a dental template is substantially similar for the mandibular and the maxillary units, with some distinctions noted in the following detailed description.

FIGS. 2A-2D illustrate exemplary maxillary denture template 1 from which a denture will be made. Maxillary denture template 1 is not sized or contoured to be in suitable condition to be worn as a denture but, rather, is pre-formed to a standard size. FIG. 2D is a cross-sectional view taken along line 2D-2D of FIG. 2A. Maxillary denture template 1 is formed of an acrylic referred to as base acrylic 3 to distinguish it from another acrylic portion that may preferably be added. Teeth 5 are already joined to base acrylic 3 in pre-formed maxillary dental template 1. Teeth 5 are conventional prosthetic teeth preferably all of the same color, typically shade 65, although any of various other shades may be used in other exemplary embodiments. Teeth 5 may be formed of various suitable conventional materials used in the dental arts. Base acrylic 3 may be formed of various suitable dental acrylics available in the dental arts. In one exemplary embodiment, the acrylic may be a long-chain methyl methacrylate polymer. Methyl methacrylate is an inorganic compound with the formula CH₂═C(CH₃)CO₂CH₃. In other exemplary embodiments, other suitable dental acrylics such as thermoplastic resins and semi-rigid reline materials may be used as base acrylic 3.

Maxillary dental template 1 includes palatal vault 7 and is defined by anterior 9 and posterior 11. The palatal vault is not present in the mandibular dental template embodiment, as will be seen in FIGS. 3 and 4. Channel 13 is a valley that is generally u-shaped and extends about maxillary denture template 1 corresponding to and for receiving the patient's edentulous alveolar ridge. Channel 13 generally takes the shape of a trough and may have a generally u-shaped cross-section or other similar and suitable cross-sections for receiving the patient's edentulous alveolar ridge. As will be shown, channel 13 of maxillary denture template 1 is only generally shaped and sized to receive the patient's edentulous alveolar ridge and only when additional acrylic or other viscous material is added to complete the denture as will be shown, will channel 13 have a suitably conformal size and shape defined by the added material, and be ready to be worn as a denture. Maxillary dental template 1 is pre-formed to a plurality of standard sizes that may be held in inventory by the dental practitioner.

When a patient with one or two edentulous alveolar ridges enters the dentist's office or onsite location for a single dental visit, the dentist will have stocked a plurality of different-sized pre-formed maxillary and mandibular dental templates. According to one exemplary embodiment, there may be four different sizes of each of the pre-formed dental templates and in another exemplary embodiment, there may be at least three different sizes, i.e., small, medium and large pre-formed dental templates, possessed by the dentist, but various numbers of differently-sized denial templates may be available in exemplary embodiments. The patient is first examined. Once it is determined no gross pathology exists, a suitably sized pre-formed denture template such as maxillary denture template 1 is chosen according to the embodiment in which the patient's edentulous ridge is the upper alveolar ridge. The proper maxillary denture template 1 size is based on sizes such as width 15 and length 17 and is chosen to minimize the amount of free space between denture template 1 and the edentulous ridge. The width of the patient's maxillary ridge and other measurements may be recorded and taken into account in selecting the appropriately sized maxillary denture template 1.

The size of maxillary denture template 1 is chosen to preferably allow the upper posterior teeth to be positioned over the center of the patient's maxillary ridge. The selected maxillary denture template 1 may have a size most closely resembling the size of the patient's anatomy. After the appropriately sized pre-formed denture template 1 is selected from the plurality of dental template sizes available, maxillary denture template 1 is then formed into a final maxillary denture customized to the patient by next adding an impression material such as a further acrylic, which will be in viscous form when added to maxillary dental template 1. According to one embodiment, a device similar to a Fox plate may be placed in the mouth against the teeth of the denture device in the patient's mouth. With such a device in place, the ala-tragal line can be followed for the correct occlusal plane angle in a superior/inferior dimension. The occlusal plane in a coronal dimension may also be noted with this device, to ensure that the occlusal plane matches the pupillary plane of the patient's eyes. Various other measurement and adjustment techniques may be used in various exemplary embodiments.

The addition of viscous impression material will now be shown with respect to a mandibular dental template in FIGS. 3 and 4.

FIG. 3 shows mandibular dental template 21, to which a further material will be added in viscous form. Mandibular dental template 21 is formed of base acrylic 23 and is defined by anterior 29 and posterior 31. Base acrylic 23 may be formed of the materials described in conjunction with base acrylic 3. Channel 33 generally receives the patient's mandibular edentulous ridge. To manufacture a custom-fit denture from pre-formed mandibular dental template 21, a further acrylic or other material is chosen to be added to mandibular denture template 21, in particular within channel 33 to serve as an impression material. The further material that will be added to base acrylic 23 to form the denture, is an impression material that is viscous when added to mandibular denture template 21 and will later be allowed to solidify by cooling, air drying, curing or by use of other suitable means, depending on the type of further material used.

FIG. 4 shows viscous material 35 being added to mandibular denture template 21. In particular, viscous material 35 is added into channel 33. Various suitable acrylic or other materials may be used as viscous material 35. In one exemplary embodiment, methyl methacrylate may be used. Other suitable acrylics such as thermoplastic acrylics may be used. In still other exemplary embodiments, conventional denial materials such as thermoplastic resins and various suitable reline materials may be used. Various other plastics and other biologically compatible materials may also be used in other exemplary embodiments. Many other appropriate materials are also available as conventional reline material in the dental prosthetics field and may be used.

Appropriate amounts of viscous material 35 are added to mandibular denture template 21 and various degrees of viscosity may be used. Viscous material 35 may be a gel, paste or other suitable composition and serves as an impression material. One commonly used material is a powder/liquid combination which may be a monomer and polymer combination that sets to a firm but resilient consistency. Alternatively stated, the initially viscous material 35 may solidify to form a semi-rigid material according to one exemplary embodiment. According to another exemplary embodiment, the initially viscous material 35 may solidify to form a rigid material. The extent of the firmness can be based on the ratio of the powder/liquid mix. For edentulous ridges that are smaller or include more friable tissue, the mix may be chosen for a softer consistency. For larger edentulous ridges with healthy tissue, the mix may be chosen to produce a firmer consistency. The type of material chosen for the patient may depend on the examination and amount of available edentulous ridge.

Two exemplary acrylic reline materials that form semi-rigid materials upon solidification, i.e., they retain some elasticity and compressibility, include MucoSOFT by Parkell Corporation of Edgewood, N.Y. and PermaSoft by Dentsply Corporation of York, Pa. Materials that form rigid materials upon solidification include MucoHARD by Parkell Corporation and Triad by Dentsply Corporation. Other suitable and commercially available materials may be used in other exemplary embodiments.

Various suitable conventional means may be used to introduce viscous material 35 into mandibular denture template 21. In one exemplary embodiment, dispenser 37 may be used to direct viscous material 35 into channel 33 of mandibular denture template 21. According to various exemplary embodiments, the components that combine to form viscous material 35 may be mixed such as in a mixing tube within dispenser 37. Other techniques for forming and directing viscous material 35 to mandibular denture template 21 may be used in other exemplary embodiments. Appropriate amounts of viscous material 35 are applied to mandibular denture template 21, being certain that there is a sufficient amount at the flanges to fully allow accurate border molding, a sufficient amount at posterior 31 to form a post dam if needed and a sufficient amount to prevent air bubbles.

Mandibular denture template 21 with viscous material 35 is then seated on the appropriate alveolar edentulous ridge in the mouth. Conventional techniques for applying suitable pressure may be used. Anterior and posterior positioning relative to the patient's upper lip may be initially carried out then checked. After the anterior/posterior positioning is carried out, further positioning is carried out.

During this time, the mandibular denture template 21 with viscous material 35 is seated on the edentulous ridge of the patient and the impression material, viscous material 35, conforms to the anatomy of the patient's edentulous ridge. Mandibular denture template 21 is fitted in the mouth to assure that there is minimal space between mandibular denture template 21 and the edentulous ridge of the patient and with sufficient pressure to produce a customized conformal denture and to force out any excess viscous material 35. After all the adjustments are carried out and the position of the mandibular denture template 21 has been determined to be correct in all three dimensions, functional border molding may be done. Conventional border molding techniques may be used. According to one exemplary embodiment, the border molding may be first done in the posterior flange areas, next in the canine areas and then in the anterior portion. Once viscous material 35 takes on the shape of the patient's anatomy after it has been finally positioned correctly and begins to solidify, the apparatus, i.e., mandibular denture template 21 with viscous material 35, is removed from the patient's mouth and excess viscous material 35 can be optimally trimmed from the buccal flange areas at this stage. The conformal, inner surface of viscous material 35 is checked for voids and to determine if any areas are void of the added viscous material 35. If any such voids are noted, additional viscous material may be added and the device reinserted and repositioned in the patient's mouth.

The viscous material 35 is then urged to solidify completely and irreversibly. The solidification may be effectuated by the cross-linking of an acrylic material that may advantageously be used, to form a long chain acrylic and this may take place by simply air drying, by cooling, or using other suitable curing techniques such as the light-stimulated curing of a photopolymerizable material to irreversibly harden viscous material 35 to form a solidified material. For other materials, other solidification techniques may be used. Depending on the particular initially viscous material 35 that was used, the solidified material may be a rigid material or a semi-rigid material with some degree of elasticity and compressibility. After solidification is complete and any additional trimming has been carried out, the fabrication of the denture in one visit is complete after checking occlusion, speech, swallowing patterns and flange finish, and the patient leaves with a customized denture.

The previously described sequence and methods apply to either the mandibular or maxillary denture template. According to one exemplary embodiment in which a patient requires both a mandibular and maxillary denture, one advantageous sequence of operations includes first fabricating the maxillary denture and then fabricating the mandibular denture. In this embodiment, the adjustment of the mandibular denture template can be made with proper occlusion to the previously fabricated maxillary denture template.

FIGS. 5A-5D show the completed custom maxillary denture formed from the corresponding denture template 1 shown in FIGS. 2A-2D and according to the method described with respect to another embodiment illustrated in FIGS. 3 and 4 which show viscous material 35 added to an exemplary mandibular dental template. Returning to FIGS. 5A-5D, maxillary denture 51 includes a first acrylic portion formed of base acrylic 3 of maxillary denture template 1 and second portion 53 formed of a further material that may preferably be acrylic and which had been added to denture template 1 as a viscous material but was urged or allowed to solidify to form solidified second portion 53 which may be rigid or semi-rigid. In a preferred embodiment, second portion 53 is formed of solidified acrylic. Maxillary denture 51 includes teeth 5. FIG. 5D best illustrates that solidified second material 53 includes buccal flange sections 57 and inner surfaces 59. It should be understood that solidified second material 53 may be formed of a non-acrylic or acrylic material. Base acrylic 3 and solidified second material 53 are in a conterminous relationship, directly contacting at interface 55.

FIG. 6 is a perspective view showing a patient that has been fitted with both a maxillary denture 51 and a mandibular denture 61. As seen most clearly in mandibular denture 61, the denture consists of teeth 5, base acrylic 23 and solidified material 63 such as formed from viscous material 35 shown in FIG. 4 and which may advantageously be an acrylic. Base acrylic 23 and solidified material 63 are conterminous materials and share interface 65.

Referring again to FIG. 2A-FIG. 2D, in accordance with another aspect of the present invention and embodiment, the preformed denture template 1 includes the base 3 formed of a thermoplastic acrylic resin. This thermoplastic becomes malleable when heated to a range or 80 deg. C. to about 110 deg. C., as in accordance with one aspect of the invention and embodiment to about 100 deg. C. The denture template 1 in its malleable state is placed on a stone model of the patient's jaw and formed to that model. The flanges of the base acrylic 23, which is discussed with respect to FIG. 3, as defined by the anterior 9 and posterior 11 of the denture template 1, are conformed closely to the model. The palate vault 7 is also conformed closely to the palate vault on the stone model. The denture template 1 can be reheated multiple times to its malleable state for close conforming to the model. The thermoplastic acrylic has no memory and stays where placed.

Referring specifically to FIG. 2B, in accordance with one aspect of the present invention, the teeth 5 are fixed in the thermoplastic by physical locking and chemical bonding. When the template is heated to a malleable state, the teeth 5 can be moved to conform to individual characteristics of the patient. The teeth 5 can be moved individually in any direction and maintain their integrity in the thermoplastic denture template 1.

Once adapted to the model, the flanges are reduced to allow 2-3 mm of space between the height of the flange and the height of the mucobuccal fold of the patient. The denture template 1 is then checked in the mouth of the patient for position and arch size, as shows in FIG. 5C. Any adjustment of the teeth 5 or the flanges can be made at this time in the thermoplastic denture template 1, which can be reheated to a malleable state. The denture template 1 is then ready for reline. The inner surface 59 of the second material 53, shown in FIG. 5D, is then placed into the denture template 1 and placed into the patient's mouth. The second material 53 conforms and adheres to the denture template 1, as shown in FIG. 5D, at the interface 55. The denture template 1 is then border molded for custom exact fit. At this point the denture template 1 loses its thermoplastic capability and the teeth and arch form are fixed.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Where a value or a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

This description of the exemplary embodiments is intended to be read in connection with the figures of the accompanying drawings, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawings under discussion. These relative terms are for convenience of description.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1-2. (canceled)

3. A method of producing a denture, said method comprising:
selecting for a patient having at least one edentulous alveolar ridge a pre-formed denture template from a plurality of pre-formed denture templates, wherein the plurality of pre-formed denture templates comprises pre-formed denture templates of at least four different sizes, wherein each pre-formed denture template of the plurality of pre-formed denture templates comprises:
a base portion formed out of a thermoplastic resin that is rigid when at a temperature less than about 80° C. and malleable when at a temperature greater than about 80° C., the base portion comprising a channel extending about a perimeter of the base portion and having an inner surface and an outer surface, wherein a shape of the channel generally corresponds to a shape of an alveolar ridge and wherein the channel is configured to at least partially accept an edentulous alveolar ridge; and
prosthetic teeth attached to the base portion;
wherein the pre-formed denture template is selected from the pre-formed denture templates of at least four different sizes to have a size generally corresponding to a size of the at least one edentulous alveolar ridge of the patient;
heating the base portion to a temperature of at least about 100° C. to render the thermoplastic resin of the base portion malleable and the base portion a malleable base portion, wherein the base portion may be made malleable by heating and then made rigid by cooling at least twice without losing structural integrity, and wherein the malleable base portion has no memory and stays where placed;
forming the malleable base portion to a stone model of a jaw of the patient, the stone model comprising at least one of an edentulous alveolar ridge and a palate vault, wherein forming the malleable base portion comprises forming at least one of a flange of the channel of the malleable base portion to at least a portion of the edentulous alveolar ridge of the stone model and forming a palate vault of the malleable base portion to the palate vault of the stone model;
reducing at least a portion the flange of the base portion until a top surface of the flange is about 2-3 mm away from a mucobuccal fold of the stone model;
after forming and reducing, cooling the base portion, placing the base portion over the edentulous alveolar ridge of the patient, and evaluating a fit of the base portion on the edentulous alveolar ridge;
after cooling the base portion, placing a viscous impression material inside the channel of the base portion of the pre-formed denture template;
positioning the channel of the base portion of the pre-formed denture template containing the viscous impression material over the edentulous alveolar ridge of the patient;
seating the pre-formed denture template on the edentulous alveolar ridge such that the edentulous alveolar ridge of the patient is pressed into the viscous impression material and toward the inner surface of the channel of the base portion, wherein the viscous impression material adheres to the base portion of the pre-formed denture template, and wherein at least a portion of the viscous impression material conforms to the edentulous alveolar ridge of the patient; and
allowing the viscous impression material to solidify.

4. The method of producing a denture of claim 3, wherein all steps of the method are performed in a single visit with a practitioner performing the method.

5. The method of producing a denture of claim 3, further comprising moving at least one tooth of the prosthetic teeth attached to the base portion to conform to a characteristic of the patient, wherein at least one tooth of the prosthetic teeth can be moved in any direction without detaching from the base portion;

6. A method of producing a denture, said method comprising:
selecting a pre-formed denture template from a plurality of pre-formed denture templates for a patient having at least one edentulous alveolar ridge, wherein the plurality of pre-formed denture templates comprises pre-formed denture templates of at least two different sizes, wherein each pre-formed denture template of the plurality of pre-formed denture templates comprises:
a base portion comprising a trough generally in the shape of an alveolar ridge and comprising a base, a front wall and a back wall, wherein the trough is configured to at least partially accept an edentulous alveolar ridge into the trough, wherein the base portion is formed out of a thermoplastic material that becomes malleable at a temperature between about 80 and 110° C. but is not malleable at temperatures below about 80° C.; and
prosthetic teeth attached to the base portion;
wherein the pre-formed denture template is selected from the pre-formed denture templates of at least two different sizes to have a size generally corresponding to a size of an edentulous alveolar ridge of the at least one edentulous alveolar ridge;
heating the base portion until at least a portion of the base portion becomes malleable, wherein the malleable portion of the base portion has no memory and remains in place after being moved;
after heating the base portion, forming a portion of the base portion to a model of a jaw of the patient, wherein the portion of the base portion formed to the model comprises at least one of a palate vault of the base portion and at least one of the front wall of the trough and the back wall of the trough;
reducing at least a portion of at least one of the front wall of the trough and the back wall of the trough to avoid an oral mucosal structure of the patient;
placing an impression material inside the trough;
positioning the trough containing the impression material over the edentulous alveolar ridge;
seating the pre-formed denture template on the one edentulous alveolar ridge such that the edentulous alveolar ridge is pressed into the impression material contained within the trough toward the base of the trough thereby causing at least a portion of the impression material contained within the trough to conform to both the trough and at least a portion of the edentulous alveolar ridge; and
allowing the impression material to solidify thereby forming a wearable mold of the edentulous alveolar ridge.

7. The method of producing a denture of claim 6, wherein all steps of the method are performed in a single visit with a practitioner performing the method.

8. The method of producing a denture of claim 6, further comprising after heating the base portion, moving at least one tooth of the prosthetic teeth from a first location in at least one dimension to a second location without removing the at least one tooth from the base portion.

9. The method of producing a denture of claim 6, further comprising after at least one of forming and reducing, placing the base portion of the pre-formed denture template over the edentulous alveolar ridge of the patient to evaluate fit of the base portion on the edentulous alveolar ridge of the patient.

10. The method of producing a denture of claim 9, further comprising repeating the heating and forming steps in response to evaluating the fit of the base portion on the edentulous alveolar ridge.

11. The method of producing a denture of claim 6, wherein during the heating step at least a portion of the base portion reaches a temperature of at least about 100° C.

12. The method of producing a denture of claim 6, wherein at least a portion of the base portion remains rigid throughout all steps of the method.

13. The method of producing a denture of claim 12, wherein only at least one of a palate vault of the base portion, the front wall of the trough, and the back wall of the trough becomes malleable as a result of the heating step.

14. The method of producing a denture of claim 12, wherein only at least one of a palate vault of the base portion, the front wall of the trough, the back wall of the trough, and a coupling location of at least one tooth of the prosthetic teeth becomes malleable as a result of the heating step.

15. A method of producing a denture, said method comprising:
providing a pre-formed denture template for a patient having at least one edentulous alveolar ridge, wherein the pre-formed denture template comprises:
a base portion comprising a u-shaped channel generally in the shape of an alveolar ridge and being configured to at least partially accept an edentulous alveolar ridge into the u-shaped channel, wherein the base portion is formed out of a thermoplastic that becomes malleable when heated to a temperature greater than about 80° C.; and
prosthetic teeth attached to the base portion;
heating the base portion so that at least a portion of the base portion reaches a temperature greater than about 80° C. and at least a portion of the base portion becomes malleable and the base portion becomes an at least partially malleable base portion;
forming at least a portion of the at least partially malleable base portion to a model of a jaw of the patient, the model comprising at least one of an edentulous alveolar ridge and a palate vault, wherein forming at least a portion of the at least partially malleable base portion comprises forming at least one of a flange of the u-shaped channel of at least partially malleable base portion to at least a portion of the edentulous alveolar ridge of the model and forming a palate vault of the at least partially malleable base portion to the palate vault of the model;
after forming at least a portion of the at least partially malleable base portion to a model, cooling the at least partially malleable base portion so that the base portion is no longer at least partially malleable;
after cooling, placing an impression material inside the u-shaped channel of the base portion of the pre-formed denture template;
positioning the u-shaped channel containing the impression material over an edentulous alveolar ridge of the at least one edentulous alveolar ridge of the patient;
seating the pre-formed denture template on the edentulous alveolar ridge such that the edentulous alveolar ridge is pressed into the impression material contained within the u-shaped channel thereby conforming at least a portion of the impression material contained within the u-shaped channel to the edentulous alveolar ridge; and
allowing the impression material to solidify into a negative of the edentulous alveolar ridge.

16. The method of producing a denture of claim 15, wherein all steps of the method are performed in a single visit with a practitioner performing the method.

17. The method of producing a denture of claim 15, further comprising selecting the pre-formed denture template for the patient having at least one edentulous alveolar ridge from a plurality of pre-formed denture templates, wherein the plurality of pre-formed denture templates comprises pre-formed denture templates of at least two different sizes.

18. The method of producing a denture of claim 15, wherein the pre-formed denture template is selected from the pre-formed denture templates of at least two different sizes to correspond to a size of the at least one edentulous alveolar ridge.

19. The method of producing a denture of claim 15, wherein the thermoplastic becomes malleable when heated to a temperature of about 110° C.

20. The method of producing a denture of claim 15, wherein the heating step comprises heating the base portion so that at least a portion of the base portion reaches a temperature of at least about 100° C.

21. The method of producing a denture of claim 15, wherein the heating step comprises heating the base portion so that at least a portion of the base portion remains rigid while at least a portion of the base portion becomes malleable.

22. The method of producing a denture of claim 21, wherein only at least one of the flange of the u-shaped channel and the palate vault of the base portion becomes malleable while the remaining portion of the base portion remains rigid and the prosthetic teeth may not be moved with respect to the base portion.

23. The method of producing a denture of claim 21, wherein only at least one of the flange of the u-shaped channel and the palate vault of the base portion and a surrounding of at least one tooth of the prosthetic teeth becomes malleable while the remaining portion of the base portion remains rigid.

24. The method of producing a denture of claim 23, further comprising moving the at least one tooth of the prosthetic teeth attached to the base portion to conform to a characteristic of the patient.

25. The method of producing a denture of claim 15, wherein the base portion may be heated to a temperature at which it is malleable and subsequently cooled to a temperature at which it is rigid at least twice without losing structural integrity.

26. The method of producing a denture of claim 15, further comprising reducing at least a portion the flange of the u-shaped channel of the base portion until a top surface of the flange is about 2-3 mm away from a mucobuccal fold of the model.

27. The method of producing a denture of claim 15, further comprising after forming and cooling, placing the base portion over the edentulous alveolar ridge of the patient, and evaluating a fit of the base portion on the edentulous alveolar ridge.

28. The method of producing a denture of claim 27, further comprising repeating at least one of the heating, forming, and cooling steps in response to evaluating the fit of the base portion on the edentulous alveolar ridge.

29. The method of producing a denture of claim 15, further comprising border molding at least a portion of the impression material around at least a portion of the u-shaped channel.

30. The method of producing a denture of claim 15, wherein the pre-formed denture template comprises at least one of a maxillary pre-formed denture template configured to conform to at least one maxillary structure of the patient comprising at least a palatal vault, and a mandibular pre-formed denture template configured to conform to at least one mandibular structure of the patient comprising at least a lingual space.

31. The method of producing a denture of claim 15, wherein the denture produced comprises a maxillary denture, the method further comprising producing a mandibular denture, wherein the maxillary denture is used to align the mandibular denture within a mouth of the patient during at least one step of producing the mandibular denture.

32. The method of producing a denture of claim 15, wherein the denture produced comprises a mandibular denture, the method further comprising producing a maxillary denture, wherein the mandibular denture is used to align the maxillary denture within a mouth of the patient during at least one step of producing the maxillary denture.
